(19) United States
(12) Patent Application Publication
(10) Pub. No.: US 2005/0080629 A1
(43) Pub. Date: Apr. 14, 2005

(54) Multi-mode interactive dialogue apparatus and method

(76) Inventors: David Attwater, Ipswich (GB); Peter J. Durston, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/500,826

(22) PCT Filed: Jan. 16, 2003
(86) PCT No.: PCT/GB03/00191

(30) Foreign Application Priority Data
Jan. 18, 2002 (GB) 0201174.0

(51) Int. Cl. G10L 11/00

(52) U.S. Cl. 704/275

(57) ABSTRACT

The invention provides a multi-modal interactive dialogue apparatus and method that has inputs and outputs of different data types, for example audio and visual. The apparatus is provided with a data store in which data relating to properties of the different types is stored, and this data may be used to control how a dialogue with a user progresses.

### TECHNICAL FIELD

The present invention relates to an interactive dialogue apparatus and method, and in particular to such an apparatus and method which allow for multi-modal inputs and/or outputs.

### BACKGROUND TO THE PRESENT INVENTION AND PRIOR ART

Finite state-based dialogue engines where the dialogue progresses by transferring control from one state to another are known in the art. In such a finite state dialogue engine each state represents a logical function in the dialogue. Typically each state has associated with it a user prompt which should elucidate a user-input event. As in all finite state engines, states have conditions associated with them that specify permissible transitions from one state to another. These conditions relate to the status of the dialogue interaction. This status may for example be modelled using a blackboard of system belief. The blackboard can be modified by the results of user-input events and/or meaning extracted from these results. It therefore models what the dialogue engine believes the user has inputted to date and therefore wishes to do. It may also contain elements of the dialogue history and other aspects of the interaction that will be discussed later. Most current dialogue engines are formally finite state engines, although their method of specifying the dialogue model may appear to be quite varied, and hence appear not to be based on a finite state model.

Our prior co-pending International patent application PCT/GB01/03261 describes a flexible mixed-initiative embodiment of such a dialogue engine. In that particular embodiment, a system blackboard is maintained. The conditions describing how to traverse from one state to another are specified by an overlaid network of conditional edges between the dialogue states. This network is parsed on each dialogue turn from a specified start state. That is the dialogue is re-parsed after every user input. At each state an ordered list of these overlaid edges is tested and the first edge which has a true condition on it is followed to a new state. This continues until an end state is found with no departing edges that may be satisfied. This end slate is taken to be the next state.

The prior art referenced above considers use of a single input and output modality at a time, and is directed at an interactive dialogue engine which performs the re-parsing operation at each input event. However, it is thought that an interactive dialogue engine which allows for multiple types of input and output forms (referred to herein as multiple modalities) will provide for a richer communication experience and environment.

### SUMMARY OF THE INVENTION

The present invention addresses the above by providing an interactive dialogue engine and method which allows for the use of multiple input and/or output modalities, thereby allowing for a richer communication experience on the part of the user. Various properties of the modalities are stored in a modality store, and the properties can be used to perform various different processing which affect how a dialogue with a user proceeds.

Therefore, from a first aspect the present invention provides an apparatus comprising:
at least one input port;
two or more output ports;
means for processing input responses to determine the semantic meaning and thereof; and
control means for determining a suitable output prompt to be output from at least one of said output ports in response to a received input response;
wherein said output ports are respectively arranged to output output prompts of different types, the apparatus further comprising:
a first store storing input and output type data indicative of one or more properties of the input and output ports and/or the input responses and output prompts communicated therethrough.

Furthermore, from another aspect the present invention also provides an interactive dialogue apparatus comprises:
two or more input ports;
at least one output port;
means for processing input responses received at one or more of said input ports to determine the semantic meaning thereof; and
control means for determining a suitable output prompt to be output from said output port in response to a received input response;
wherein said input ports are respectively arranged to receive input responses of different types; the apparatus further comprising
a first store storing input and output type data indicative of one or more properties of the input and output ports and/or the input responses and output prompts communicated therethrough.

These aspects of the invention therefore provide a first store storing input and output type data indicative of one or more properties of the input and output ports and/or the input responses and output prompts communicated therethrough. This allows for various processing steps to be performed utilising the data stored in the store and which affect how the dialogue with the user progresses.

Moreover, there is preferably also provided a second store storing data defining a dialogue model which models a dialogue to be held with a user, and dialogue transition conditions which must be met to allow a user to progress through the dialogue, at least some of said conditions involving the stored input and output type data.

Also, there is preferably provided a second store storing data defining a dialogue model comprising an initial state, a plurality of subsequent states, possible transitions between said states, and for each transition an associated condition to be satisfied before that transition is deemed allowable, at least some of said conditions involving the stored input and output type data.

In addition, preferably the different types of output prompts or input responses comprise audio prompts or responses, or visual prompts or responses, or motor prompts or responses, in any combination thereof.

From another aspect the invention provides An interactive dialogue method comprising:
receiving input responses at least one input port;
processing the input responses to determine the semantic meaning thereof; and
determining a suitable output prompt to be output from at least one of two or more output ports in response to a received input response;
wherein said output ports are respectively arranged to output output prompts of different types; the method further comprising:
storing input and output data indicative of one or more properties of the input and output ports and/or the input responses and output prompts communicated therethrough.

Moreover the invention further provides An interactive dialogue method comprising:
receiving input responses at least one or more input ports;
processing the input responses received at one or more of said input ports to determine the semantic meaning thereof; and
determining a suitable output prompt to be output from an output port in response to a received input response
wherein said input ports are respectively arranged to receive input responses of different types; the method further comprising:
storing input and output data indicative of one or more properties of the input and output ports and/or the input responses and output prompts communicated therethrough.

The aspects of the invention therefore provide the steps of storing input and output type data indicative of one or more properties of the input and output ports and/or the input responses and output prompts communicated therethrough. This allows for various processing steps to be performed utilising the data stored in the store and which affect how the dialogue with the user progresses.

Further features and aspects of the invention are defined in the accompanying claims.

### BRIEF DESCRIPTION OF THE DRAWINGS

Further features and advantages of the present invention will become apparent from the following description of an embodiment thereof, presented by way of example only, and with reference to the accompanying drawings, wherein like reference numerals refer to like parts, and wherein:

FIG. 1 is a system block diagram of a computer system which may implement the present invention.

FIG. 2 is a block diagram of the overall system architecture of an interactive dialogue apparatus;

FIG. 3 is a block diagram of a dialogue manager as used in our earlier co-pending International patent application no. PCT/GB01/03261;

FIG. 4 is a block diagram showing one possible mode of operation of a dialogue apparatus according to the present invention;

FIG. 5 is a block diagram of a dialogue manager as used in the embodiment of the present invention;

FIG. 6 is a Venn diagram showing how modalities of the present invention may fall into various categories;

FIG. 7 is a flow diagram illustrating how a dialogue with a user may progress;

FIG. 8 is a dialogue state transition diagram illustrating an aspect of the invention;

FIG. 9 is a dialogue state transition diagram illustrating another aspect of the invention; and

FIG. 10 is a dialogue state transition diagram illustrating yet another aspect of the invention.

### OPERATING ENVIRONMENT OF THE EMBODIMENT OF THE INVENTION

The background operating environment of the preferred embodiment of the present invention will now be described. The reader should note that the background operating environment of the embodiment is similar to that as described in our earlier co-pending International patent application no. PCT/GB01/03261, from which the following is taken.

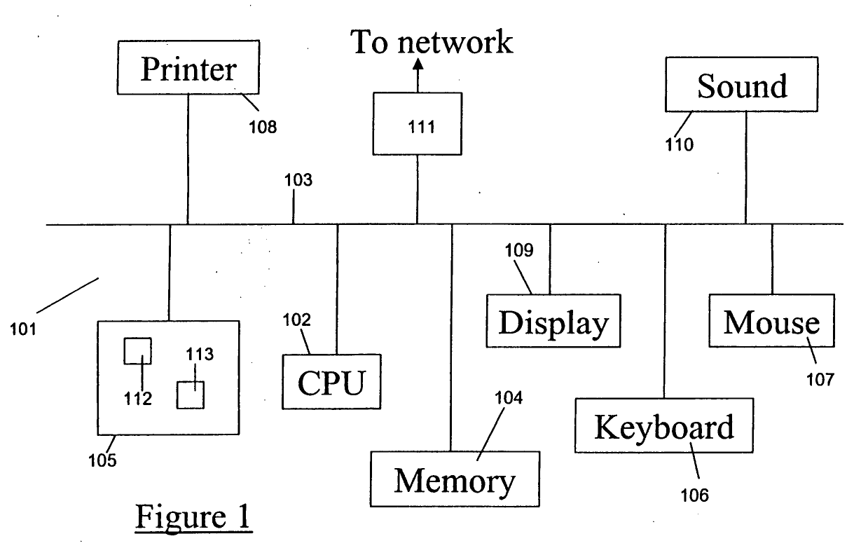

In terms of hardware, the system of the embodiment may be implemented on a standard desktop computer 101 (FIG. 1).

The computer 101 has a central processing unit 102 connected to a bus 103 for communication with memory 104, a conventional disc storage unit 105 for storing data and programs, a keyboard 106 and mouse 107 for allowing user input and a printer 108 and display unit 109 for providing output from the computer 101. The computer 101 also has a sound card 110 and a network connection card 111 for access to external networks (not shown).

The disc store 105 contains a number of programs which can be loaded into the memory and executed by the processor 102, namely a conventional operating system 112, and a program 113 which provides an interactive voice response apparatus for call steering using a natural language interface.

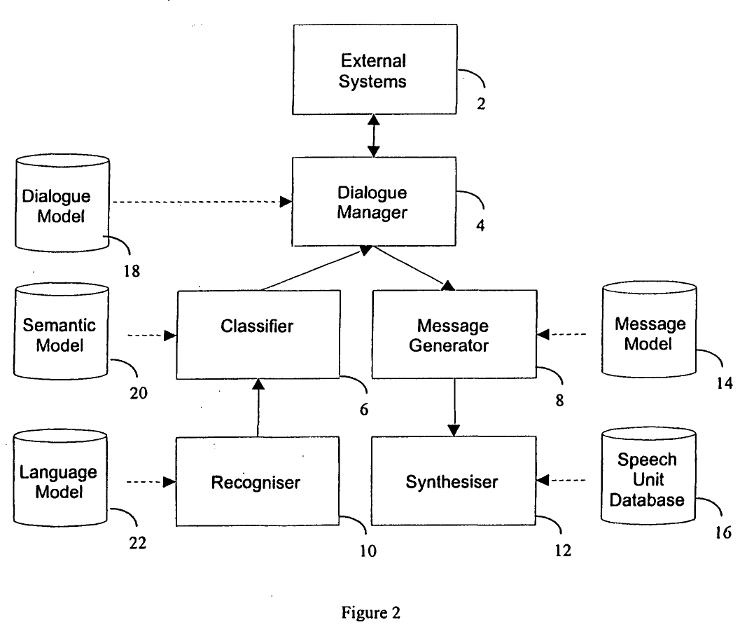

The program 113 operates in accordance with the architecture represented by the functional block diagram shown in FIG. 2. A user's speech utterance (received by the network card 111 or sound card 110 of FIG. 1) is fed to a speech recogniser 10. The received speech utterance is analysed by the recogniser 10 with reference to a language model 22, which is one of a plurality (not shown) of possible language models. The language model 22 represents sequences of words or sub-words which can be recognised by the recogniser 10 and the probability of these sequences occurring. The recogniser 10 analyses the received speech utterance and provides as an output a representation of sequences of words or sub-words which most closely resemble the received speech utterance. The representation is assumed, in this example, to consist of the most likely sequence of words or sub-words: (alternatively, a “second-choice” sequence, or some other multiple-choice representation such as the known “graph” representation of the mostly likely sequences could be provided).

Because recogniser results are expected to be very error prone, the recogniser also provides confidence values associated with each word in the output representation. The confidence values give a measure related to the likelihood that the associated word has been correctly recognised by the recogniser 10. The recogniser output including the confidence measures is received by a classifier 6, which classifies the utterance according to a predefined set of meanings, by reference to a semantic model 20 (which is one of a plurality (not shown) of possible semantic models) to form a semantic classification. The semantic classification comprises a vector of likelihood, each likelihood relating to a particular one of the predefined set of meanings. The term ‘robust parser’ is also used for components of this kind. Given a single utterance, classifiers and parsers can return multiple meanings taken from different pre-defined sets simultaneously.

A dialogue manager 4, forms the heart of the system. It serves to control the dialogue, using information from a dialogue model 18. It can instruct a message generator 8 to generate a message, which is spoken to the user via the telephone interface using the speech synthesiser 12. The message generator 8 uses information from a message model 14 to construct appropriate messages. The speech synthesiser uses a speech unit database 16 which contains speech units representing a particular voice. The dialogue manager 4 also instructs the recogniser 10 which language model to use for recognising a user's response to the particular generated message, and also instructs the classifier 6 as to the semantic model to use for classification of the response. If text input is required, then the recogniser 10 can be omitted or bypassed. If direct meaning tokens are to be input then the classifier may also be considered optional.

The dialogue manager receives the user's responses, as output from the classifier 6, and proceeds, potentially, via further prompts and responses, to a conclusion whereupon it issues an instruction (in this example) via the network connection 111, shown in FIG. 1, to external systems (not shown) (for example, a computer telephony integration link for call control or customer records database).

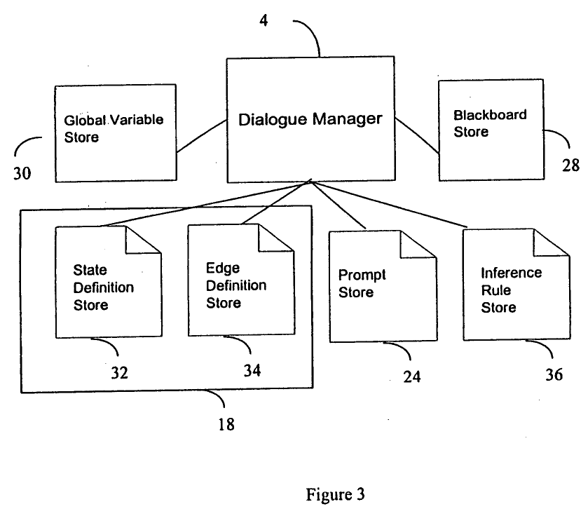

The dialogue manager has a store 28 (FIG. 3), referred to here as the blackboard store, in which it records information gathered during the dialogue. This includes (a) information representing the dialogue manager's current “belief” as to what the user's requirements are, (b) transitory information gained from the dialogue, and (c) a state history.

The dialogue manager uses the state model 18. A number of states are defined by data stored in a state definitions store 34, whilst possible transitions (referred to as edges) from a state to another state (the successor state) are defined by data stored in an edge definitions store 34. This data also includes, associated with the edges, logical conditions involving the information stored in the blackboard store. The state definition data and edge definition data together form the model 18.

The way that the state model works is that the dialogue manager parses the model, in that, starting from a start state, it examines the edges leading from that state and if an edge condition is satisfied it proceeds to the successor state corresponding to that edge. This process is repeated until it can go no further because no edge condition is satisfied (or no edge is present). The state thus reached is referred to as the current state: the identity of this is appended to the state history stored in the blackboard store. This history is used by the dialogue manager to decide on the next prompt (using a prompt store 24). The dialogue manager also serves to enter data into the blackboard store and to manage the blackboard store using inference rules in an inference rule store 36. In practice, the stores 32, 34, 24, 36 are formed from different areas of the store 113 shown in FIG. 1.

### DESCRIPTION OF THE EMBODIMENT

Having described the background operating environment of the embodiment, specific details thereof will now be described.

The embodiment of this invention relates to a multi-modal dialogue engine where the user can interact using one or more modalities for input, and the dialogue engine responds with one or more output modalities. By “modality” we mean a type of input or output data, such as, for example, audio data, picture data, text data, or motor data. Examples of each type are given later. Also, herein the description uses the term ‘interaction’ for the dialogue experience with a specific user.

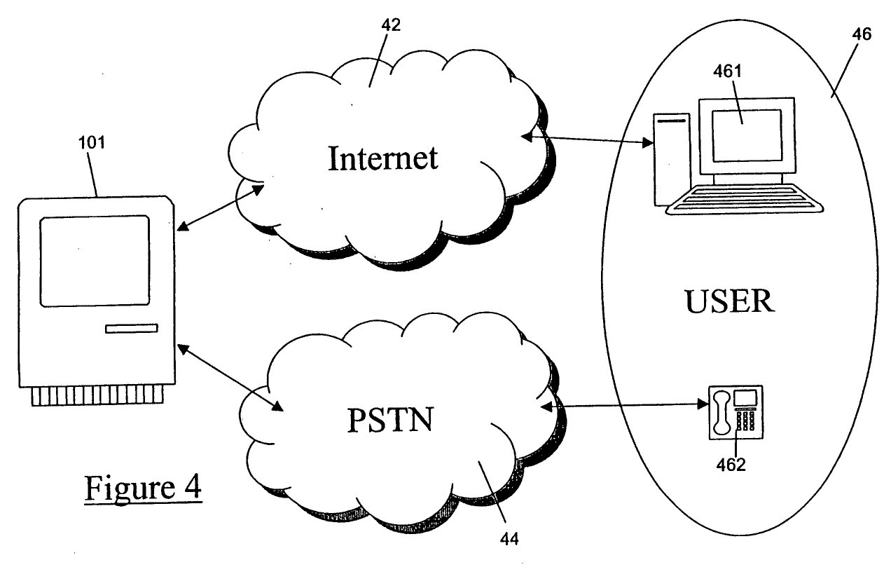

FIG. 4 illustrates the operational scenario for the embodiment of the invention. In FIG. 4 a computer system 101 hosting the interactive dialogue apparatus is arranged to communicate with a user 46, who is provided with his own computer 461, as well as a telephone 462. The computer system 101 has a connection to a network 42 such as the Internet, to which the user's computer 461 is also connected. Additionally, the computer system 101 is also connected to the user's telephone 462 via the public switched telephone network 44. Preferably both the internet 42 and the PSTN 44 provide duplex communications to and from both the user's computer 461, and the telephone 462. Furthermore, by their nature both the telephone 462 and the computer system 461 may be used as both input devices by the user, and output devices by the dialogue apparatus. In other embodiments of the invention this may not be the case, depending on the specific devices available to the user (a computer mouse, for example, would be an input device only, whereas a monitor would be an output device only). Alternative configurations are possible, for example the voice call could also be carried on the internet using voice over IP (VoIP) protocols.

In operation the dialogue apparatus 101 can output audio signals via the PSTN to the user's telephone 462, and may also receive audio signals therefrom. In addition, the dialogue apparatus 101 may also output both audio and video signals to the computer system 461 via the internet 42, and may receive audio, video, or motor (such as keystrokes or mouse movements) input therefrom. Thus in this example the apparatus is capable of outputting and inputting outputs and input of different types (different modalities).

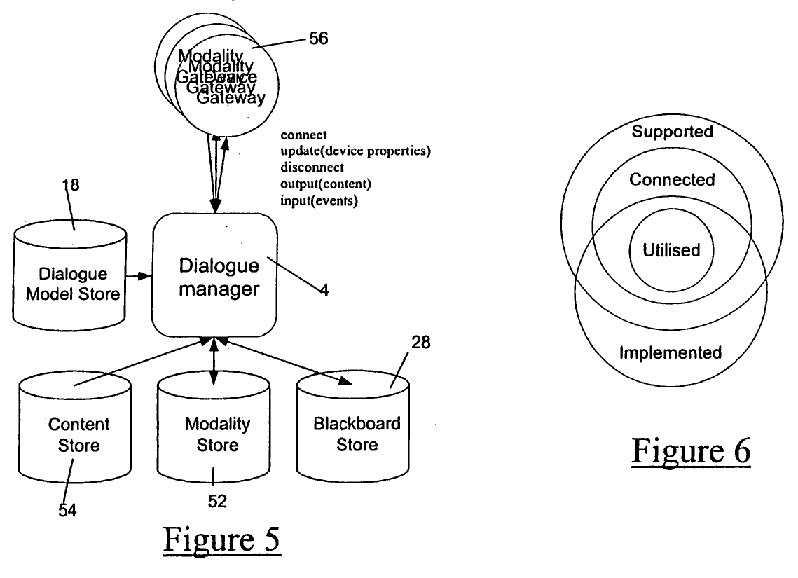

FIG. 5 shows the additional elements added by the embodiment of the present invention to the dialogue apparatus. More particularly, the dialogue manager has access to four stores as shown in FIG. 5. The dialogue manager, as in all finite state engines, uses the Dialogue Model Store 18 where the dialogue itself is specified. This contains a description of the states and conditions for transitioning between them. The blackboard store 28 models the system's belief of what the user is trying to achieve within the interaction. Typically this is a set of feature value pairs with optional confidences. e.g. “Task: bookTickets: 90%”, as described previously.

A further store, the content store 54, contains content to be output to the user. This may contain XML based (e.g. HTML, WML, etc.) data, speech recordings, graphics, or URLs describing the file location of such content. This store is analogous to the prompt store 24 described previously, but with the extension that it stores data of different types for each modality. Thus where previously the prompt store 24 may have stored just speech and text files, the content store 54 may in addition store picture and video data, for example. Generally, the content store will store output data suitable for each available modality.

The final store is a modality store 52, which contains information on the different modalities. This is discussed in detail later in this description.

The dialogue manager 4 interfaces with the user devices via device “gateways” 56. There will typically be one device gateway for each device but this is not an essential feature of this invention. Each gateway is attached to one or more input and/or output “ports” provided by the apparatus, and an input or output “port” is provided for each modality. Thus, it is possible for multiple gateways to be connected to the same port, provided the devices to which each gateway connected to the same port require the same modality. If a given device supports multiple input and output modalities its gateway could also be connected to multiple “ports”. As an example, consider where the user is provided with a personal digital assistant capable of displaying pictures, and a laptop computer. Here, both the PDA and the laptop will have respective output gateways providing visual output from the interactive dialogue apparatus 101, and each gateway will be connected to the same port (the visual out port). Similarly, as both a PDA and a laptop can also be used as input devices (most conveniently motor input devices), each device will have an input gateway connected to the motor input port at the dialogue apparatus. Such a logical arrangement of “ports” and “gateways” allows for the same modality to be input or output from or to more than one user device at the same time. The gateways also send and receive connect/disconnect messages concerning modality management. This is discussed later.

Within this description a modality can be one of two types dependent on the direction of information: input or output. Input modalities are means by which the user can provide information to the dialogue manager. Correspondingly the dialogue manager can respond by returning one or more output modalities to the user.

As well as the direction of information, modalities are also grouped according to the human sense they address. A number of modalities are listed in the table below, for example Audio-input, Audio-output, Visual-input, Visual-output, Motor-input, and Motor-output. Also in the table are examples of devices that are used to deliver output or receive input. Throughout this description a modality name contains both the sense and direction of information flow. These categorisations have been found to be helpful when modelling multi-modal dialogue. They are not the only way to model different communication modes and this invention would apply to other ways of categorising modalities as well.

Examples of both input and output modalities are shown in the table below together with example devices that are used to interpret or render them.

TABLE 1

| | Input | Output |
|---|---|---|
| Audio | Speech- | Text-to-speech (TTS) |
| | Recogniser | Synthesiser |
| | Vocal Emotion | Sound file player |
| Visual | Camera | Screen |
| | eye tracker | web browser |
| | lip sync | WAP phone |
| | gesture | DVD/video player |
| | facial emotion | avatar rendering engine |
| Motor | Hands | Robot |
| | mouse | Acceleration Simulator |
| | keyboard | Robot Arm |
| | touch screen | Computer controlled vehicle |
| | thumb-wheel | |
| | telephone keypad | |

In the preferred embodiment of this invention a single, unified dialogue model is used for all modalities. Input from any mode that is semantically synonymous leads to the same dialogue state transition. Therefore a similar interaction can be obtained using different modes by inputting semantically synonymous inputs. Modes can be freely mixed. For example, typing or speaking the same responses at a point in the dialogue will give the same interaction (provided both inputs are understood, and so reduced to the same semantic representation). However a single unified dialogue model is not a prerequisite for this invention. A distributed system, where the functions of the dialogue engine are divided between different components can also utilise this invention. Likewise the modality store need not be physically all in one place. If the dialogue model and/or the modality store are distributed the only pre-requisite for this invention is that the state of some or all distributed modality stores must be available to some or all distributed parts of the dialogue model. For simplicity in the preferred embodiment we assume that the dialogue model is unified and the modality store is in one centralised place, although the reader should note that this is not essential, and either one or both of the dialogue model or modality store may be stored on distributed interconnected storage media.

In any one embodiment of this invention, based on the hardware infrastructure available to the dialogue engine, a set of modalities is ‘supported’. In addition an application using the dialogue engine has a number of modalities ‘implemented’, i.e. the dialogue model and content stores are capable of dealing with input and generating output appropriately for these modalities. The modalities that are implemented at any given moment will depend on the specific dialogue state that the engine is currently in and the modalities implemented by the content associated with this state. A single modality can thus be ‘supported’ (by the surrounding hardware infrastructure), implemented (in the dialogue engine) or both.

In addition at any given moment in any one interaction a subset of the modalities will be ‘connected’, i.e. available for sending output content and receiving input. Furthermore, a subset of these connected modalities will be in use by the user—down to their preference or environmental situation. Such modalities are termed ‘utilised’. Thus modalities can be split into four categories: Supported, Implemented, Connected and Utilised. The modality sets are related as shown in FIG. 6.

TABLE 2

| | Audio | Audio | Visual | Visual | Motor | Motor |
|---|---|---|---|---|---|---|
| | Input | Output | Input | Output | Input | Output |
| Supported | Yes | Yes | Yes | Yes | Yes | No |
| Implemented | Yes | Yes | Yes | Yes | No | Yes |
| Connected | Yes | Yes | No | Yes | Yes | No |
| Utilised | Yes | No | No | Yes | No | No |

Table 2 above shows an example at one given moment in an interaction. A dialogue manager has the hardware infrastructure capable of supporting input and output over five modalities. Likewise the dialogue model and content has five modalities implemented. However in this particular interaction only four are connected. Note that the motor-input modality is connected and, although supported, has not been implemented in the dialogue model and content. It is therefore not possible for the user to utilise this modality. The user, however, limits the modalities further by choosing not to use audio-output. Therefore only two modalities are labelled as ‘utilised’.

Modality information, such as that shown above, is maintained in the modality store 52. The dialogue manager already has a blackboard store 28 used to model system belief regarding the current interaction. To extend to a multi-modal interaction a new store is used, although in practice this can be adequately implemented on the same blackboard if so chosen. The modality store preferably contains to following elements as shown below in Table 3:

TABLE 3

| | |
|---|---|
| Which modalities | Is the dialogue engine hardware and software surround |
| are supported | capable of supporting this modality? |
| Which modalities | Is a modality implemented for a specific state in the |
| are implemented | dialogue model and content store? |
| Which modalities | At a point in the interaction, is the modality connected |
| are connected | and so available for receiving input/presenting content? |
| Which modalities | At a point in the interaction, is the modality used by |
| are utilised | the user? (this is only relevant for input modalities) |
| User modality | At a point in the interaction, does the user show or |
| preferences | express a preference for this modality? (note this may |
| | be modelled as a probability or Boolean) |
| Properties of | For each connected modality - what device properties |
| device(s) used for | are used to receive input/present output content? |
| each connected | |
| output modality | |

The modality store consists of a number of entries, an example of which is shown below in Table 4.

TABLE 4

| Modality | Supported | Implemented | Connected | Utilised | Preference | Device Properties |
|---|---|---|---|---|---|---|
| Audio Input | yes | yes | yes | yes | yes | Speech |
| | | | | | | Recogniser |
| | | | | | | (telephony, 01234 |
| | | | | | | 5678910) |
| Motor Input | yes | yes | yes | no | no | PDA HTML |
| | | | | | | Browser (thumb- |
| | | | | | | wheel, stylus, |
| | | | | | | keyboard) |
| Audio | yes | yes | yes | — | yes | TTS Engine |
| Output | | | | | | |
| Visual | yes | yes | yes | — | no | PDA Web Browser |
| Output | | | | | | (600 × 800 pixels, |
| | | | | | | 50 Kb/s) |

Each entry, as shown above, records the supported, implemented, connected, utilised and (user) preference status of each modality using Boolean values (true or false) reflecting the status of each modality. Additional entries record the properties of the device used for the input or output event. Each piece of data in a modality entry is now discussed in turn:

Details of whether a modality is supported tend to be set up at the start of the interaction (since they relate to the infrastructure surrounding the dialogue engine). This may therefore, for efficiency reasons, be implemented using a global modality store for each interaction containing these static details However it is important that the dialogue engine has access to this information.

The implemented status at any point in the interaction is directly related to the current dialogue state. Portions of the dialogue may only be implemented for a subset of the supported modalities. This status may be inferred given the current dialogue state and the corresponding entry in the content store. i.e. Has content been defined enabling the modality in question to be used for this state? In the described embodiment this data is stored in the modality store. However in an alternative embodiment, this information may be derived from the dialogue model and content stores directly.

The connected status, defining whether the modality is available for input or output, is also a Boolean value. In one embodiment of this invention, the modalities that are connected are defined at the start of the interaction and cannot change during it. This has the advantage that all the modalities can be synchronised together so that the dialogue engine (which may be running more than one interaction with different users at a given time) knows which, say, audio-output device corresponds to which motor-input device. An alternative, as in the present embodiment, is to allow the connected status to change throughout an interaction as modalities are enabled and disabled. This approach requires the sending and receiving of messages between the dialogue engine and device gateways in order to keep this store up to date. Our earlier co-pending British patent application no 0108044.9 describes how such a store may be kept up to date using a mapping function.

An example of the above would be a ‘callMe button’ that is selected by the user part way through a web initiated interaction. This adds two modalities (audio-input and audio-output) to those that were already connected. Conversely ceasing a modality, such as hanging up on a telephony channel, will remove those modalities (audio-input and audio-output) from those that are connected for the remainder of the interaction.

Furthermore an interaction that starts using one modality (e.g. a HTML browser offering visual-output and motor-input) may introduce a further modality at some point (e.g. audio-input and audio-output) and then, by ending the visual HTML modalities, transfer over to audio-input and audio-output modalities only.

The store relating to utilised modalities is only relevant to user input events—logging which, out of a set of connected modalities, were used for input. This status can be modelled as a Boolean (the modality was or was not used) and may change for each dialogue state visited in the interaction history.

The modality store also contains user preferences for a modality. These may be Boolean values for each modality—based on a user profile (for example, an identified used may have previously selected that they don't wish to use Audio-in modalities, for example, due to the risk of being overheard). This status can be updated during an interaction either explicitly by asking an explicit question (e.g. ‘would you prefer to interact using your voice?’) or by implicitly by inference from the modality's utilisation. The inference mechanism mentioned above (from our earlier co-pending International patent application no. PCT/GB01/03261) could be used again to achieve this. Thus for example, a caller who repeatedly chooses one modality over others will be assumed to have a preference for that modality.

In addition the modality store records properties of the devices used for input or output events. This is primarily described using a set of device types (e.g. Speech Recogniser, TTS Engine, Web Browser, etc.). The modality properties are further clarified by other appropriate information. This either relates to the capabilities of the device (e.g. screen size, telephony or non-telephony speech quality), or the properties of the interconnecting network (e.g. bit rates for data transfer, for telephony the calling line identity—CLI—disclosing if the device is a mobile or landline telephone).

The ‘connect’ message used to change the connected status of a modality is also used to define the device properties through which the new modality is to be mediated. These properties, which are added to the modality store, will persist until the device sends the ‘disconnect’ message.

An extension to this mechanism would be possible if an additional message were implemented to allow devices to change their properties during connection. This is unlikely but may be useful for noting properties such as connection bandwidth which may vary during a devices connection.

In the case of a telephony platform the ‘connect’ message is triggered when an incoming call is detected and answered (thereby opening the audio-input and audio-output modalities) and conversely when the user hangs up the ‘disconnect’ message is sent from the telephony platform.

For visual content the presence or otherwise of a visual browser must be detected. This can be achieved by establishing a session between, say, the web client and the web gateway (i.e. web server). This is an established technique in the web world and may be achieved by several methods, for example by storing cookies on the user's local device or by explicit logon screens. In the latter example when the user wishes to use the visual browser they first register this using the registration screen. Conversely when they wish to leave the web session they access the logout screen which send the disconnect message to the dialogue engine for the visual-output modality (and also motor-input).

As the interaction progresses the modality store is kept up to date. There are three mechanisms which may be used to do this. For each interaction these mechanisms are:
1) Entries, such as those above, are added sequentially to the modality store on input events. Therefore the whole interaction modality history is recorded. This is the preferred embodiment. Additionally the time of output and input events can be recorded in the modality store;
2) A single entry is maintained for each modality and the contents (status of each modality) updated on input events. This may be boolean or a score;
3) A sequential store as in (i) above and a single score entry as in (2) above.

The scores in the single entry store can be used to give an aggregated summary of the history of a particular modality to date. This score can made probability-like, for example by using a window size fixed to N dialogue events, the total number of times each modality has been used in the window may be calculated and each total normalised to sum to one across all alternatives. Thus if a caller uses the same modality for N events then the probability for this item would be set to one. Other schemes for example one based on non-rectangular windows (for example a decaying, weighted window with smaller weights for turns further back in the interaction history) could be used.

Alternatively the score for a modality could be based on a combination of the previous score value plus the modality status of the current state. This alternative could be used to implement option (2) above. The single probability may be derived via a function from the sequential boolean store, or maintained independently. Our earlier co-pending International patent application no. PCT/GB01/03261 provides an inference mechanism that could be used to calculate the single aggregate value.

It would also be possible to have other modality store entries whose values are derived from one or more functions of the values of other of the modality store entries—an example of this would be the ability to derive the value (Boolean or otherwise) of an “active” entry, from, for example, a combination of the “implemented” and “connected” entries.

Also in some instances an additional modality store or modality store entires relating to the confidence that input types are being interpreted correctly could be added. For example the pattern matching process used in speech recognition could report low confidence for a given input event. Successive low confidence events could signal difficulty for that particular input type—e.g. background noise.

Either way, within the preferred embodiment of this invention the modality store is updated each time the dialogue engine transitions to a new state. A state change doesn't have to be as a result of semantic information (such as the information entered by the user) it can also be, as in (2) above, as a result of a modality connection status change. The latter may be initiated by the user, dialogue engine or device gateway (for example in response to technical failure of a device or gateway for a particular device.)

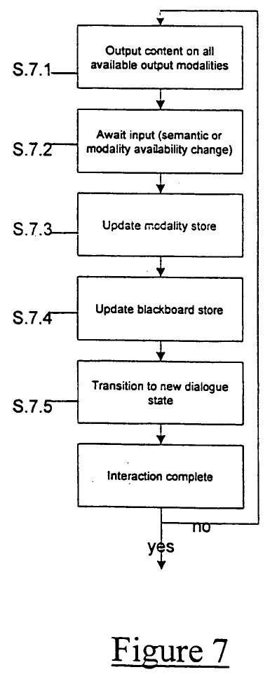

The control flow for the dialogue manager will now de discussed, with reference to FIG. 7.

As mentioned previously, as well as the connect/disconnect messages each gateway can also report input results. These may be that a user has spoken a word or phrase, selected a web link, entered text on a web page, and so on. These inputs are processed to generate the semantic information that they represent and that semantic data added to the blackboard store 28.

Once an input has been received, either new semantic information or a change in the connected modalities, both the blackboard and modality stores are updated. New semantic information is added to the blackboard, as described previously in our earlier co-pending International patent application no. PCT/GB01/03261. The dialogue engine then selects the next dialogue state which will generate the next appropriate response. The dialogue may, after re-evaluating to determine the next state find that no state change is necessary. This dialogue flow can be summarised as shown in FIG. 7.

Here, at step 7.1 the output content for the present output event in the dialogue is output on the available modalities (determined by reference to the modality store—supported and connected). Then, at step 7.2 the apparatus waits for a user response, and upon receipt of a response (which may be either a semantic response directly answering the output prompt, or more subtly a change in the available modalities, for example due to the passing of a connection/disconnection message) processes the response to determine its semantic or otherwise meaning.

Next, at step 7.3 the apparatus updates the modality store 52 as appropriate, and then updates the blackboard store 28 at step 7.4. The dialogue model in the dialogue model store 18 is then accessed, and the edge conditions for a state transition examined, and a state transition performed if the edge conditions are met at step 7.5. This then completes a single dialogue output/input transaction.

Once in the new state, the content for each connected modality is presented to the user on returning to step 7.1. At each dialogue state the dialogue engine is able to generate output content for each of the implemented output modalities. For example at a dialogue state at which the caller's date-of-birth is to be determined, the dialogue engine can generate output content such as shown in Table 5:

TABLE 5

| Modality | Example Content |
|---|---|
| Audio- | Speech file (e.g. a way file) ”What_dob.wav’ |
| Output | A textual representation of a speech prompt (i.e. ”what's your |
| | date of birth?”) which may contain mark-up for a TTS engine |
| Visual- | A textual representation of a speech prompt (i.e. ”what's your |
| Output | date of birth?”) which may contain mark-up for a TTS engine |
| | WML ready for display on a WAP phone |
| | XML data for rendering in some way |

Each time a new state is transitioned to, the dialogue manager outputs implemented content on each connected (and so supported) output modality. Although output content can be presented on all implemented output modalities it is only presented on those that are currently connected (by looking at the last modality store entry for that output modality). Moreover the device properties are used to determine through which gateway or mechanism the content should be presented. For example, visual-output content for a WAP phone should be sent to a WAP gateway, whereas Visual-output HTML content should be sent to the web server. In the current embodiment these both share the visual-output port so both gateways will actually receive both types of content and select the appropriate type, but this is not an essential implementation feature.

Note this invention does not restrict the number of devices using the same modality. For example it is possible to both view visual content on a WAP phone and web browser on a desktop PC. In some cases this parallel use of a single modality is not helpful due to sharing of the physical device. For example parallel use of the audio-output modality for TTS and the same content in a recorded speech form may be undesirable.

However content is only presented if it has changed. This prevents the same content being repeated to the user, which is both wasteful (on both network resource, processing power) and gives a poor, repetitive interaction. In the current embodiment the dialogue manager performs this check by storing on the blackboard uniquely identifying details (e.g. file locations) of the previous output content for each modality, and comparing new content with each before updating. Only modified content is re-rendered. In another embodiment each device gateway or even the device itself could perform this check.

Comparing current output content to previous output has been used previously in our earlier co-pending International patent application no. PCT/GB01/03261. Therein such comparison was in the context of an interactive voice response embodiment where only audio-input and audio-output modalities were supported. In the embodiment of the present invention a repeated audio prompt is used as a means of terminating a dialogue. When more modalities are connected the same idea can also be used. However a check is now made that none of the connected (and implemented) modalities output content has changed. If any one modality changes then the interaction is still progressing.

In practice this additional feature is useful for transaction-based interactions where there is a strongly defined goal towards which the dialogue model is leading the user—for example a sale or change in account details. In these instances, to maintain quality of service, bailing-out of the transaction to a human agent in a multi-media contact centre for example would be appropriate if a user is not progressing through the dialogue. However for more casual multi-modal browsing it is less appropriate to implement this mechanism.

The description so far details a multi-modal dialogue manager using a modality store. The modality store is used to appropriately manage the multi-modal dialogue. In the present invention two ways to achieve this are described:
A) Using the modality store to affect which states are transitioned to; and
B) Using the modality store to affect the content that is presented at a given state.

In each case the five different aspects of the modality store (connected status, utilised status, implemented modes, user preference and properties) can be used in isolation or combination to tailor the interaction to suit the modalities and devices in operation.

In the case of (A) above the modality store is used in the state transition conditions to select the next appropriate state. In a typical dialogue engine the blackboard store (which models system belief of what the user is wishing to do) is used in determining which state to transition to. In the present invention this is extended to include modality information from the modality store. This enables, for example, portions of the interaction to be barred from the user if certain conditions are not met. For example, if the interaction can offer the user a conversation with a human agent, this only makes sense if the modalities necessary (audio-in and audio-out in this case) are connected. This example is expanded on later.

In addition to using the modality store for selecting the next state at a specific point in the interaction, there are also patterns of interaction that perform meta-dialogue. Meta-dialogue, or dialogue about dialogue, is important for managing the multi-modal interaction effectively. It can be used to inform the user of the dialogue's multi-modal capabilities, modalities they may wish to use but are not utilising, confirm inferred preferences, etc. Examples of such meta-dialogue follow in this description. Meta-dialogue has the characteristic that many states in the dialogue will be able to transition to a single state or group of states—i.e. the conditions for entering a meta-dialogue will be largely independent of the exact point in the interaction. Implementing meta-dialogue therefore requires duplication of the same set of states in many places in the dialogue. This, although possible, is inelegant and leads to large dialogue models.

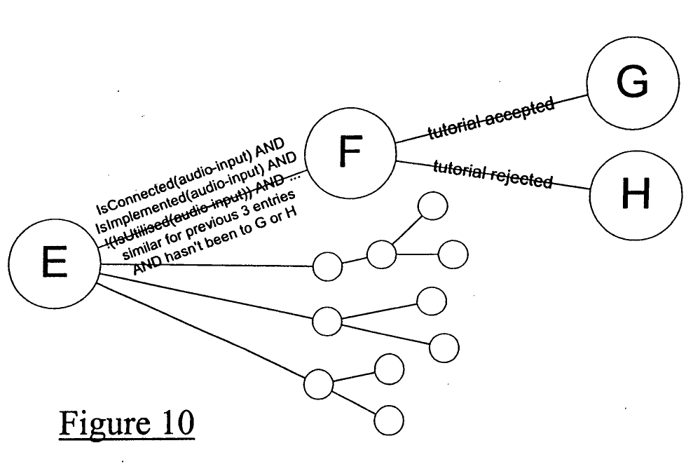

An alternative to repeating meta-dialogue from each state is to use a re-parse technique as described in our earlier co-pending International patent application no. PCT/GB01/03261. Although it is not necessary to use such a technique in the current invention, it's inclusion leads to a smaller and more efficient dialogue model. In a re-parse dialogue engine the next dialogue state is determined by re-parsing the dialogue model from a pre-defined start state every time a new dialogue state is sought. Thus meta-dialogue states can be positioned within the dialogue model as shown in FIG. 9 Adding the meta-dialogue states near the start state means the condition (for the transition between states labelled ‘Start’ and ‘Meta’) is tested every time a new state is sought. If, for example the condition is: “IsConnected(audio-input) && !(IsUtilised(audio-input)) && !(visited Meta state before in interaction)”.

(N.B. the above condition uses notation similar to ANSI C to denote logical ANDs and NOTs) then when the audio-input modality is connected but not used by the user the interaction moves into state Meta where, for example the user could be reminded that they can use the audio input modality is they wish. Note that the condition above also tests that the Meta state has not been already visited in the same interaction.

The example condition above also illustrates that modality-based state transition conditions often use more than one aspect of the modality store (in this case Connected and Utilised). A simple extension of this condition would be to include user preference. If the user is known to have a preference not to use the audio-input then the meta-dialogue above is not appropriate and should thus be avoided.

Using this approach (or an equivalent in a different dialogue model representation scheme), multiple meta-dialogues that are specific to different regions of the dialogue model may also be implemented by situating the Meta state lower down in the dialogue description graph. The deeper a meta-state is situated the more specific its function.

Examples of the use of meta- and state-specific dialogue transitions that depend on the modality store are now presented in turn.

### EXAMPLE 1

### State-Specific Dialogue Selected Due to Modality Store

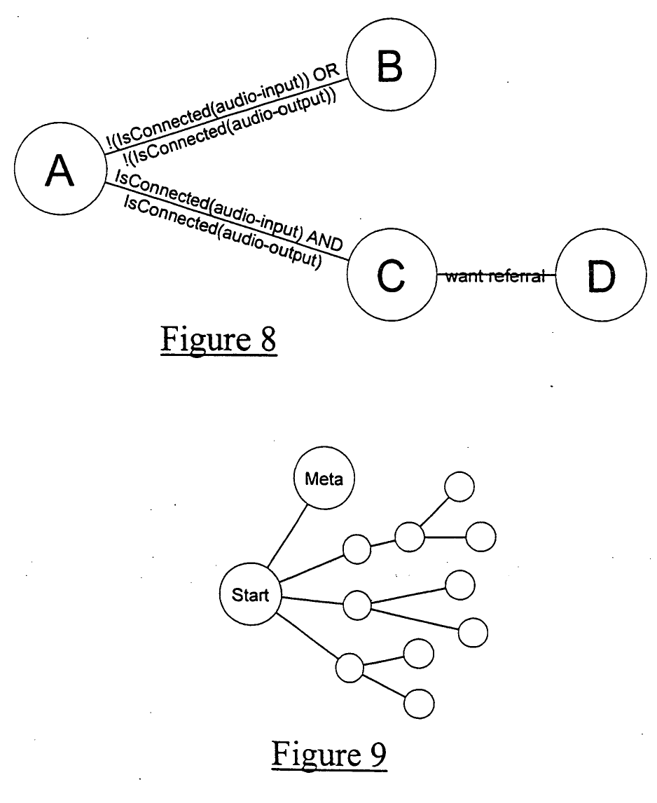

In this example, showing a portion of the dialogue model is shown in FIG. 8. For this illustration the interaction is currently in state A. Depending on whether the audio-input and audio-output modalities are both connected, or not, the interaction progresses into state B or C respectively. If the dialogue reaches state B there is no further state to progress to. At this point the user would be instructed that they need audio-input and audio-output modalities to be connected in order to satisfy the current need that they have expressed in the dialogue (and speak to a human agent at state D). In this case the dialogue engine uses a re-parse technique and so when the modalities connection status changes (either by the user enabling them—e.g. by making a telephone call to the system, or by the system enabling them—e.g. making a call to the user) the model is re-parsed and moves to state C. In this state the user is asked if they would like referral to a human agent and once confirmation is received the interaction is completed.

Note that if a re-parsing dialogue is not used a new interconnecting condition can be added between states B and C with the same condition as state A to C.

### EXAMPLE 2

### Meta-Dialogue Selected Due to Modality Store

FIG. 10 shows a use of meta-dialogue (assuming a re-parse technique is implemented in the dialogue manager running this model). In this case the modality store consists of a sequence of entries so modality history can be incorporated in the state transition conditions. The condition here is true if for the past three modality entries the audio-input modality has been connected, implemented (in the dialogue model) but not utilised and the interaction has not previous contained the meta dialogue (i.e. states G or H have yet to be visited). In such cases the state F is transitioned to the next time the dialogue model is re-parsed. In state F a number of possibilities exists. The user could be prompted (on all connected and implemented output modalities) as follows:
“I notice you are not using speech input. Would you like to disable speech interaction totally?”.

It may be more appropriate use a wording specific to the device properties using that modality, e.g. “would you like to hang up?” if the user is using a telephone.

An alternative for state F is for the system to terminate the modality without asking the users permission. In such instances the system should notify the user of the change e.g. “I am going to disconnect the telephone connection as you have not been using it. If you wish to reconnect, simply press the call-me button on the screen.”. This could be particularly appropriate is the user is known to have a preference not to use this modality, or the use of this particular modality has a cost associated with it.

Adopting the model shown in the figure, the system offers a tutorial on using the audio-input modality. Once the tutorial is either accepted (with the tutorial presented in state G) or declined (and not presented in state H) the meta-dialogue is prevented from occurring again in that interaction.

In order to query which states have been previously visited in an interaction the blackboard store needs to keep a record of a state history. This is discussed in our earlier co-pending International patent application no. PCT/GB01/03261—although, like a re-parse technique, is beneficial to the implementation of the ideas in the current invention but not essential.

### EXAMPLE 3

### Dialogue Model Based on Device Properties

Some parts of the dialogue may, for example, require a large display for displaying graphic-rich content. Excluding those areas of the dialogue from users will maintain quality of the interaction within the constraints of the devices currently being used.

For example imagine a photo retrieval application. The dialogue may have reached a stage where the caller is to select one of a number of photographs to be printed or mailed to someone. It is know that a visual output modality is connected, but depending on the device propertied used to present visual output a different set of dialogue states are used. If only a small PDA screen is present, or there is a low bandwidth to the device, then there may be some dialogue states that manage, verbally or otherwise, the navigation through the images presented one at a time as thumbnail sketches on the screen. Alternatively all of the images may be presented as a number of tile thumbnail sketches at once by a different parallel state. Once this is clarified subsequent states may be shared again.

Meta-dialogue can also be triggered on the device properties. For example if, as above, the interaction will be enhanced when viewing with a large display and the user is currently interacting via a smaller display that is compromising the interaction, it may be appropriate to inform the user of this. A prompt (on all connected and implemented output modalities) such as “In future you may find it easier to access this service with a larger display” would convey this to the user. It may be particularly helpful when entering regions of the dialogue which will require certain properties to warn the users in advance that they may be lacking certain device properties in advance of them actually reaching that point in the dialogue.

In the case of (B)—where the output content is selected based on the modality store—the interaction can again be tailored. This will usually be a more subtle effect than the modified dialogue, but will increase the usability of the user interface and may avoid confusion. Using this aspect of the invention the same state can prompt the user (on all connected and implemented output modalities) in a customised fashion dependent on the modality store. The five aspects of the modality store (connected status, implementation status, utilised status, user preference and properties) can be used independently or together to achieve this.

An example is now given of one underlying mechanism for generating content associated with a given state. Here we extend the mechanism for prompt generation described in our earlier co-pending International patent application no. PCT/GB01/03261.

By way of review of the mechanism described in our earlier co-pending International patent application no. PCT/GB01/03261, consider an example implementation where the speech output modality audio content is generated by concatenation of one or more audio files. The list of speech files that require concatenation is generated using a list of rules such as those below. This mechanism is formally equivalent to the use of a set of generative grammar rules which are turned on and off by qualifying conditions which test the state of the blackboard store. In this example the dialogue engine determines that the audio output required, at a given state, is defined by the token <time of day>. This is then expanded using rules such as:
<time of day>=“<time> <am/pm>” IF (TRUE)
<am/pm>=am.wav IF ($am/pm==am)
<am/pm>=pm.wav IF ($am/pm==pm)
<time>=“<hour> <o'clock>” IF ($minutes==0)
<time>=“<halfPast> <hour>” IF ($minutes==30)
<time>=“<hour> <minutes>” IF ($minutes !=0 and $minutes !=30)
<o'clock>=“o'clock.wav” IF (TRUE)
<halfPast>=“halfPast.wav” IF (TRUE)
<hour>=“one.wav” IF ($hour==1)
<hour>=“two.wav” IF ($hour==2) etc.
   where variables (marked with the symbol ‘$’) relate to the system belief as modelled on the blackboard store. This mechanism allows content to be generated dependent on the blackboard store contents. For the multi-modal invention under discussion content for all output modalities be can similarly generated with reference to the blackboard store and, in addition, the modality store.

In this invention output content for selected modalities may be provided. As described previously, several devices may be used implement the same output modality. Defined content may be shared between several devices of the same output modality. However, this may not be appropriate, in which case additional conditions may be used on multiple generative grammar rules to select different rules for each type of implementation. Therefore different devices may be given different content for the same state, possibly at the same time.

Consider the example used earlier in FIG. 8. In state C the user is asked if they would like to be referred to a customer services agent. The audio output content (i.e. speech files or text for TTS) could be different depending on the other modalities connected. For example if a visual modality such as the web were active it would be appropriate to offer connection in the context of other information:
“Here's some information on this service. Would you like to discuss this with a customer service advisor?”.

However if the visual content is not presented (as no visual output modalities are connected and implemented) then a shorter wording is more appropriate such as: “Would you like to speak to a customer services advisor about this?’.

A further similar example would be a web page where the text
“Please enter your postcode [symbol]
   could, if an audio-input modality is connected, be replaced by:
“Please say or enter your postcode

[symbol]

The above examples change specific output content for a specific state in the dialogue. However there are phrases that it is more efficient and convenient to change globally. For example the token <inputinvitation> is widely used when prompting for input. In the audio output content it is given the value according to the following rules:
<inputInvitation>=“say.wav” IF (IsConnected(audio-input) && !(IsConnected(motor-input)))
<inputInvitation>=“say_or_enter.wav” IF (IsConnected(audio-input) && IsConnected(motor-input))
<inputInvitation>=“enter.wav” IF (!(IsConnected(audio-input)) && IsConnected(motor-input)).
   So in a prompt “<please> <inputInvitation> <your name>” the appropriate speech files will be played depending on which modalities are connected.

Global tokens such as <inputInvitation> can also be used in modalities such as visual-output. For example, a banner can be selected for inclusion in more than one visual output content. Depending on the users device properties, say, either a small or large display, different banners can be selected. Furthermore since the device properties for a modality contain information on the connecting channel (such as data transfer rates) this can be used to inform the visual-output content to prevent long download times. A graphic rich or text only version of the content can be selected accordingly.

Another example of two devices that access the same modality is a landline and a mobile phone. The speech recordings played to each of these could be different to reflect the likely calling environment. For example the audio output to a landline may contain background music, whereas to a mobile this would cause a noticeable degradation in intelligibility of the speech. Mobile phone coding schemes play music very poorly, as they are primarily optimised to code speech. The mobile output could therefore contain clearer recordings, optimised for intelligibility in noisier environments.

For example consider the audio output at the start of a service. The initial prompt may contain music or not, e.g.
<welcome>=“welcome_no_music.wav” IF (ModalityProperties(Audio)==mobile)
<welcome>=“welcome_music.wav” IF (ModalityProperties(Audio) !=mobile).

Since a single modality may have a number of devices that users can use to interact through there is potentially many different examples of output content that can be provided customised precisely for each device. In practice using optimised content for some of the more common devices and generic content for the remainder provides a realistic solution.

The user's modality preference (either explicitly determined from a user profile, or inferred from a pattern of modality utilisation) can also be used to affect the exact content presented to the user. If, for example it is found that motor-input is preferred over audio-input (even though both input modalities are connected and implemented) the unused modality could assume a ‘supportive’ role. That is rather than using modality-independent wordings for the audio output such as “what's your surname?” the alternative “please enter your surname” could be used. The audio output prompt is now directing the caller to use their modality of choice—it has become supportive of the caller's preferred modality. In such a case all active modalities remain accessible and can be used by the caller, but the emphasis is moved to the preferred modality.

In the same example the reverse is also true. A caller who uses only spoken input, rather than motor-input, can be prompted (on all connected and implemented output modalities) for speech using wordings such as ‘please say your surname’—no reference made to the motor-input modality. Therefore the modality of choice is changed to direct only for that modality and all other modalities become supportive of that—prompting for just that input modality (i.e. the visual content is changed to “please say your . . . ” rather than “ . . . enter . . . ”).

1. An interactive dialogue apparatus comprising:
at least one input port;
two or more output ports;
means for processing input responses to determine the semantic meaning thereof; and
control means for determining a suitable output prompt to be output from at least one of said output ports in response to a received input response;
wherein said output ports are respectively arranged to output output prompts of different types; the apparatus further comprising
a first store storing input and output type data indicative of one or more properties of the input and output ports and/or the input responses and output prompts communicated therethrough.

2. An interactive dialogue apparatus comprising:
two or more input ports;
at least one output port;
means for processing input responses received at one or more of said input ports to determine the semantic meaning thereof; and
control means for determining a suitable output prompt to be output from said output port in response to a received input response;
wherein said input ports are respectively arranged to receive input responses of different types; the apparatus further comprising
a first store storing input and output type data indicative of one or more properties of the input and Output ports and/or the input responses and output prompts communicated therethrough.

3. An apparatus according to claim 2, and further comprising at least one additional output port, wherein said control means is further arranged to determine a suitable output prompt to be output from at least one of said output ports in response to a received input response; and wherein said output ports are respectively arranged to output output prompts of different types.

4. An apparatus according to claim 1, wherein for any particular received input prompt, output prompts which are semantically synonymous or which mutually contribute towards a single semantic message independent of type are output from two or more of the output ports.

5. An apparatus according to claim 1, wherein each input or output port is adapted to connect to one or more input or output devices via respective device gateways.

6. An apparatus according to claim 1, wherein one of said properties is the utilisation made by a user of each input and output port.

7. An apparatus according to claim 1, wherein one of said properties is the connection of appropriate input or output devices to each of said input or output ports.

8. An apparatus according to according to claim 1, wherein one of said properties is user preference value for each of said input and output ports.

9. An apparatus according to according to claim 1, wherein one of said properties is device property data of input or output devices connected to said input or output ports.

10. An apparatus according to according to claim 1, wherein one of said properties is implementation data indicative of: whether an output prompt has been implemented in each output prompt type; and/or input parse rules for each input response type.

11. An apparatus according to according to claim 1, wherein one of said properties is type-supported data indicative of whether the apparatus is capable of receiving and/or outputting input responses and/or output prompts of each type.

12. An apparatus according to claim 1, wherein said input and output type data is updated when: i) any of said one or more properties change; and/or ii) output prompts are sent; and/or iii) input responses are received.

13. An apparatus according to claim 12, wherein the update of said data comprises instantiating new data structures to store the values of said changed properties, and storing said previous data to give a historical record of said data.

14. An apparatus according to claim 1, wherein said input and output type data further includes timing data indicative of the timings of changes in said one or more properties.

15. An apparatus according to claim 1, wherein said input and output type data comprises a single data entry for each input and output type, the value taken by a particular data entry being dependent on previous values of any one or more of that or other data entries.

16. An apparatus according to claim 1, comprising a second store data defining a dialogue to be held with a user, and dialogue progression conditions which must be met to allow a user to progress through the dialogue, at least some of said conditions involving the stored input and output type data.

17. An apparatus according to claim 1, and further comprising a second store storing data defining a dialogue model comprising an initial state, a plurality of subsequent states, possible transitions between said states, and for each transition at least one associated condition to be satisfied before that transition is deemed allowable, at least some of said conditions involving the stored input and output type data.

18. An apparatus according to claim 16, wherein the second store comprises a plurality of distributed storage media.

19. An apparatus according to claim 1, and further comprising port control means for controlling the connections of input or output devices to said input or output ports in response to the stored input and output type data.

20. An apparatus according to claim 1, and further comprising means for generating output prompts, said means being operable to generate output prompts adapted for particular output ports in dependence on the stored input and output type data.

21. An apparatus according to claim 1, wherein said first store comprises a plurality of distributed storage media each logically interconnected.

22. An apparatus according to claim 1, wherein the different types of output prompts or input responses comprise audio prompts or responses, or visual prompts or responses, or motor prompts or responses, in any combination thereof.

23. An interactive dialogue method comprising:
receiving input responses at least one input port;
processing the input responses to determine the semantic meaning thereof; and
determining a suitable output prompt to be output from at least one of two or more output ports in response to a received input response;
wherein said output ports are respectively arranged to output output prompts of different types; the method further comprising:
storing input and output data indicative of one or more properties of the input and output ports and/or the input responses and output prompts communicated therethrough.

24. An interactive dialogue method comprising:
receiving input responses at least one or more input ports;
processing the input responses received at one or more of said input ports to determine the semantic meaning thereof; and
determining a suitable output prompt to be output from an output port in response to a received input response
wherein said input ports are respectively arranged to receive input responses of different types; the method further comprising:
storing input and output data indicative of one or more properties of the input and output ports and/or the input responses and output prompts communicated therethrough.

25. A method according to claim 24, wherein said determining step is further arranged to determine a suitable output prompt to be output from at least one of a plurality of output ports in response to a received input response; and wherein said output ports are respectively arranged to output output prompts of different types.

26. A method according to claim 23, wherein for any particular received input prompt, output prompts which are semantically synonymous or which mutually contribute towards a single semantic message independent of type are output from two or more of the output ports.

27. A method according to claim 23, comprising connecting any one or more of the input or output ports to one or more input or output devices via respective device gateways.

28. A method according to claim 23, wherein one of said properties is the utilisation made by a user of each input and output port.

29. A method according to claim 23, wherein one of said properties is the connection of appropriate input or output devices to each of said input or output ports.

30. A method according to claim 23, wherein one of said properties is a user preference value for each of said input and output ports.

31. A method according to claim 23, wherein one of said properties is device property data of input or output devices connected to said input or output ports.

32. A method according to claim 23, wherein one of said properties is implementation data indicative of whether an output prompt has been implemented in each output prompt type.

33. A method according to claim 23, wherein one of said properties is type-supported data indicative of whether the apparatus is capable of receiving and/or outputting input responses and/or output prompts of each type.

34. A method according to claim 23, wherein said input and output type data is updated when: i) any of said one or more properties change; and/or ii) output prompts are sent; and/or iii) input responses are received.

35. A method according to claim 34, wherein the update of said data comprises instantiating new data structures to store the values of said changed properties, and storing said previous data to give a historical record of said data.

36. A method according to claim 23, wherein said input and output type data further includes timing data indicative of the timings of changes in said one or more properties.

37. A method according to claim 23, wherein said input and output type
data comprises a single data entry for each input and output type, the value taken by
a particular data entry being dependent on previous values of any one or more of that
or other data entries.

38. A method according to claim 23, and further comprising storing data defining a dialogue to be held with a user, and dialogue progression conditions which must be met to allow a user to progress through the dialogue, at least some of said conditions involving the stored input and output type data.

39. A method according to claim 23, and further comprising storing data defining a dialogue model comprising an initial state, a plurality of subsequent states, possible transitions between said states, and for each transition at least one associated condition to be satisfied before that transition is deemed allowable, at least some of said conditions involving the stored input and output type data.

40. A method according to claim 38, wherein said data defining the dialogue model is stored on a plurality of storage media each of which is logically interconnected.

41. A method according to claim 23, and further comprising controlling the connections of input or output devices to said input or output ports in response to the stored input and output type data.

42. A method according to claim 23, and further comprising the step of generating output prompts adapted for particular output ports in dependence on the stored input and output type data.

43. A method according to claim 23, wherein said input and output type data is stored on a plurality of distributed storage media.

44. A method according to claim 23, wherein the different types of output prompts or input responses comprise audio output prompts or input responses, or visual output prompts or input responses, or motor outer prompts or input responses, in any combination thereof.

45. A computer program or suite of programs so arranged such that when executed on a computer the program or programs cause the computer to perform an interactive dialogue method according to claim 23.

46. A computer program or suite of programs so arranged such that when loaded into a computer it or they renders the computer an apparatus according to claim 1.

47. A computer readable storage medium storing at least a computer program or at least one of a suite of programs according to claim 45.
